(19) United States
(12) Patent Application Publication
(10) Pub. No.: US 2011/0062037 A1
(43) Pub. Date: Mar. 17, 2011

(54) Slide-Open Package of Tobacco Articles, and Relative Production Method

(75) Inventors: Ivanoe Bertuzzi, Casalecchio Di Reno (IT); Flavio Trebbi, San Lazzaro Di Savena (IT); Andrea Biondi, Bologna (IT)

(73) Assignee: G.D SOCIETA' PER AZIONI, Bologna (IT)

(21) Appl. No.: 12/881,596

(22) Filed: Sep. 14, 2010

(30) Foreign Application Priority Data
Sep. 17, 2009 (IT) BO 2009A000590

(51) Int. Cl. B65D 85/10; B31B 49/02

(52) U.S. Cl. 206/267; 493/84

(57) ABSTRACT

A slide-open package of tobacco articles, having a parallelepiped-shaped inner container which houses a group of tobacco articles and has two opposite, parallel major lateral walls; a parallelepiped-shaped outer container which has two opposite, parallel major lateral walls and houses the inner container to allow the inner container to slide between a closed position, in which the inner container is inserted inside the outer container, and an open position, in which the inner container is at least partly withdrawn from the outer container; and at least one coupon located between a first major lateral wall of the inner container and a major lateral wall of the outer container.

### TECHNICAL FIELD

The present invention relates to a slide-open package of tobacco articles and relative production method.

In the following description, reference is made, for the sake of simplicity, to a slide-open packet of cigarettes, though purely by way of example.

### BACKGROUND ART

Rigid, hinged-lid packets of cigarettes are currently the most marketed, by being easy to produce and easy and practical to use, and by effectively protecting the cigarettes inside.

In addition to rigid, hinged-lid packets of cigarettes, rigid, slide-open packets of cigarettes have been proposed comprising two partly separable containers inserted one inside the other. That is, a rigid, slide-open packet of cigarettes comprises an inner container, which houses a group of cigarettes wrapped in a sheet of foil wrapping material, and is housed inside an outer container to slide, with respect to the outer container, between a closed position, in which the inner container is inserted inside the outer container, and an open position, in which the inner container is withdrawn from the outer container. The inner container may slide in and out of the outer container in either a straight translatory movement, or by swinging about a hinge connecting the two containers.

Embodiments of rigid, straight slide-open packets of cigarettes are described in Patents FR2499947A1, U.S. Pat. No. 4,534,463A1, U.S. Pat. No. 5,080,227A1 and IT1169163B; one embodiment of a rigid, swing-open packet of cigarettes is described in Patent Application WO2006021581; and some packets of cigarettes contain a coupon in the form of a single or fan-folded sheet printed with advertising or pictures.

In rigid, slide-open packets, the coupon is normally inserted between the outer container and a sheet of transparent plastic overwrapping material. This has the advantage of the coupon being removable immediately when the packet is unsealed, but also has the drawback of the coupon concealing large part of the printed surface of the outer container, which should preferably be left visible to the user.

To solve the problem, it has been proposed to insert the coupon inside the inner container, directly contacting the group of cigarettes. This solution, however, has the drawback of making the coupon difficult to remove from the inner container without first removing at least some of the cigarettes from the packet. Moreover, the size of the coupon is seriously limited, on account of the normally small size of the cigarette extraction opening of the inner container, which makes it impossible to extract a coupon wider than roughly half the width of the inner container; and the fact that the coupon is positioned directly contacting the group of cigarettes poses the problem of colourants in the printing on the coupon releasing odours which may alter the aroma of the tobacco.

### DESCRIPTION OF THE INVENTION

It is an object of the present invention to provide a slide-open package of tobacco articles and relative production method, which are designed to eliminate the above drawbacks and, at the same time, are cheap and easy to implement.

According to the present invention, there are provided a slide-open package of tobacco articles and relative production method, as claimed in the attached Claims.

### BRIEF DESCRIPTION OF THE DRAWINGS

A number of non-limiting embodiments of the present invention will be described by way of example with reference to the accompanying drawings, in which:

FIG. 1 shows a front view in perspective of a rigid, straight-slide-open packet of cigarettes in accordance with the present invention and in a closed configuration;

FIG. 2 shows a front view in perspective of the FIG. 1 packet of cigarettes in an open configuration;

FIG. 3 shows an exploded view in perspective of the FIG. 1 packet of cigarettes;

FIG. 4 shows a front view in perspective of a rigid, swing-open packet of cigarettes in accordance with the present invention and in a closed configuration;

FIG. 5 shows a front view in perspective of the FIG. 4 packet of cigarettes in an open configuration;

FIGS. 6 and 7 show front views of the FIG. 4 packet of cigarettes in a closed and open configuration respectively, and highlighting some of the internal component parts of the packet;

FIG. 8 shows a plan view of a blank from which to form an inner container of the FIG. 1 packet of cigarettes;

FIG. 9 shows a plan view of a blank from which to form an outer container of the FIG. 1 packet of cigarettes;

FIGS. 10-15 show schematics illustrating attachment of a coupon to the FIG. 8 blank when forming the FIG. 1 packet of cigarettes;

FIGS. 16-21 show schematics illustrating attachment of a coupon to an inner container when forming the FIG. 1 packet of cigarettes.

### PREFERRED EMBODIMENTS OF THE INVENTION

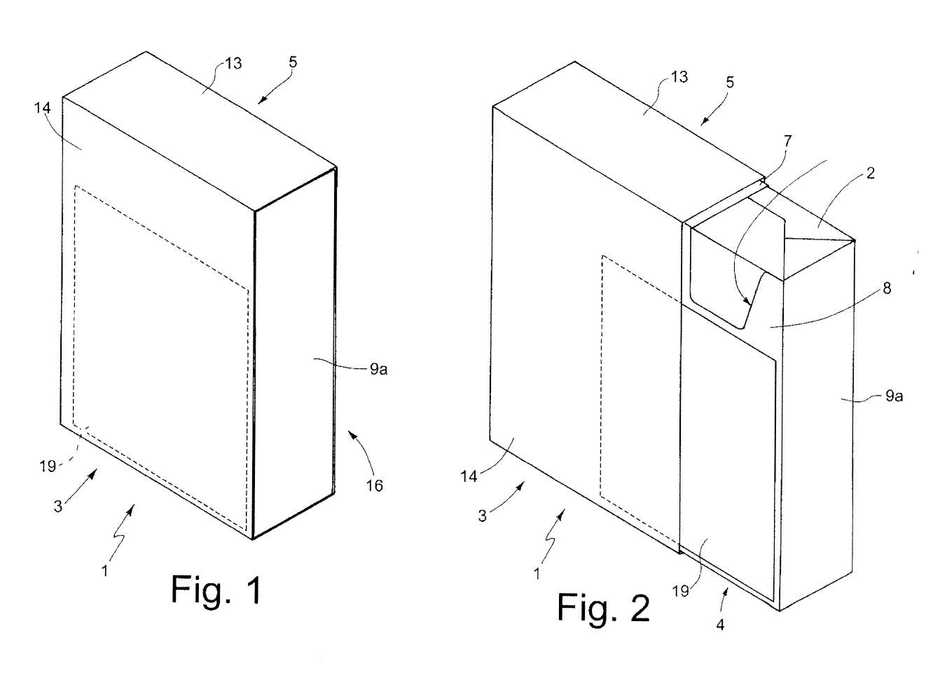

Number 1 in FIG. 1 indicates as a whole a rigid, straight-slide-open packet of cigarettes.

The packet 1 of cigarettes in FIG. 1 comprises a wrapped group 2 of cigarettes (not shown), i.e. a group of cigarettes wrapped in a sheet of foil wrapping material; and a rigid outer package 3 made of cardboard or similar, housing wrapped group 2, and in turn comprising a rigid inner container 4 actually housing wrapped group 2, and a rigid outer container 5 housing inner container 4 to allow inner container 4 to slide, in a straight movement with respect to outer container 5, between a closed position (FIG. 1), in which inner container 4 is inserted completely inside outer container 5, and an open position (FIG. 2), in which inner container 4 is withdrawn partly from outer container 5 for direct user access to wrapped group 2.

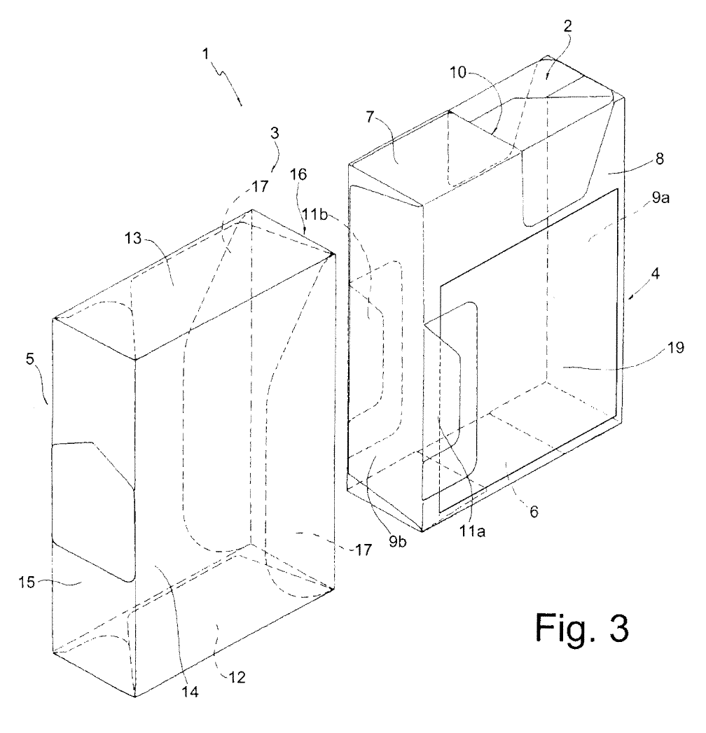

As shown in FIG. 3, inner container 4 is parallelepiped-shaped, and comprises a bottom wall 6, atop wall 7, two opposite parallel major lateral walls 8, and two parallel minor lateral walls 9a, 9b interposed between major lateral walls 8. Close to minor lateral wall 9a, top wall 7 has an extraction opening 10 also extending over part of major lateral walls 8, and which, when inner container 4 is in the open position, is located outside outer container 5 to allow the user to extract the cigarettes (not shown) from inner container 4, after first tearing open the wrapping of group 2. A retaining tab 11 is cut from each major lateral wall 8, close to minor lateral wall 9b, and projects outwards of inner container 4 from the edge between respective major lateral wall 8 and minor lateral wall 9b. Four longitudinal edges are defined between major lateral walls 8 and minor lateral walls 9, and eight transverse edges are defined between lateral walls 8, 9 and walls 6, 7.

As shown in FIG. 3, outer container 5 is also parallelepiped-shaped, and comprises a bottom wall 12, atop wall 13, two opposite parallel major lateral walls 14, a minor lateral wall 15, and an opening 16 opposite minor lateral wall 15 and through which inner container 4 slides. A retaining tab 17 is connected to the edge of each major lateral wall 14 bounding opening 16, projects inwards of outer container 5 from respective major lateral wall 14, and, as inner container 4 slides out, engages a corresponding retaining tab 11 of inner container 4 to limit the outward travel of inner container 4 and prevent inner container 4 from detaching completely from outer container 5. Two longitudinal edges are defined between major lateral walls 14 and minor lateral wall 15, and six transverse edges are defined between lateral walls 14, 15 and walls 12, 13.

Minor lateral wall 15 of outer container 5 has a central hole shaped and sized to allow the user to exert pressure, through minor lateral wall 15, on minor lateral wall 9b of inner container 4, to slide inner container 4 into the open position.

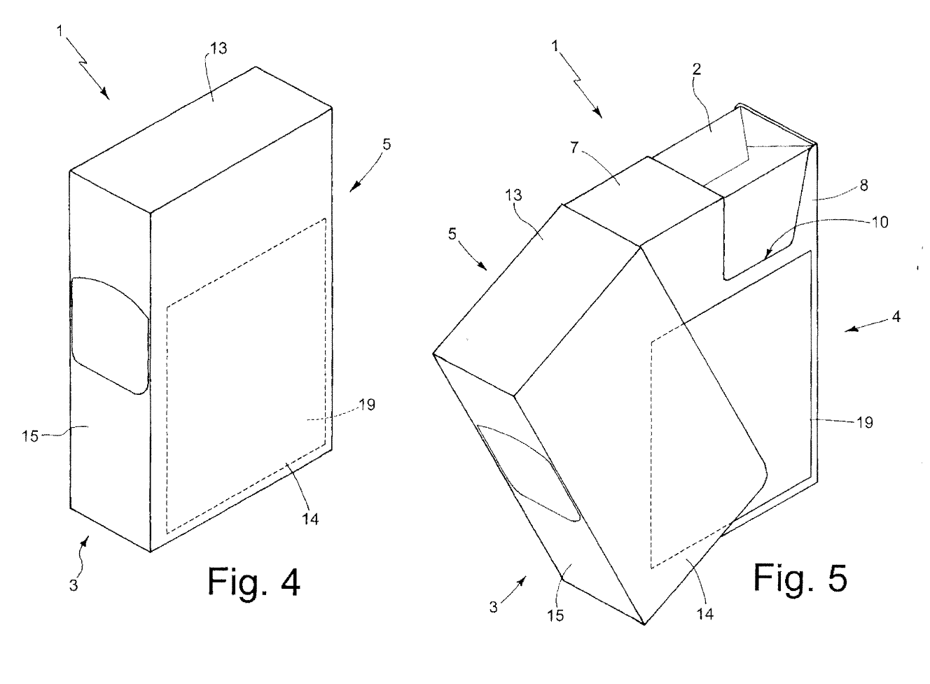

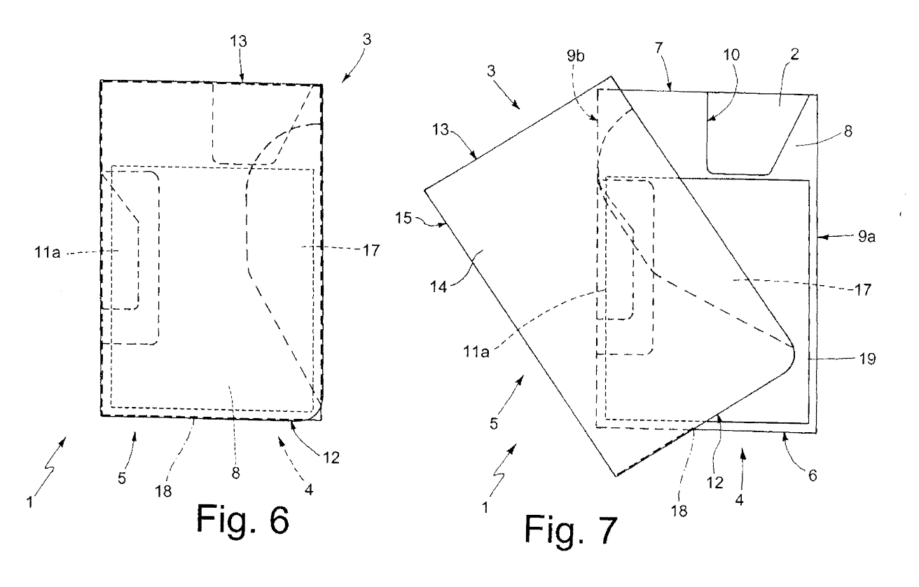

Packet 1 of cigarettes in the FIG. 1-3 embodiment slides straight open, i.e. inner container 4 moves between the open and closed positions with respect to outer container 5 in a translatory movement (i.e. a straight movement in a direction parallel to the major transverse edges); whereas packet 1 of cigarettes in the FIG. 4-7 embodiment swings open, i.e. inner container 4 moves between the open and closed positions with respect to outer container 5 in a rotary movement about a hinge 18 connecting bottom wall 6 of inner container 4 to bottom wall 12 of outer container 5. In other words, packet 1 of cigarettes in FIGS. 4-7 differs from packet 1 of cigarettes in FIGS. 1-3 by inner container 4 being hinged (i.e. connected) to outer container 5 at hinge 18, whereas inner container 4 of packet 1 of cigarettes in FIGS. 1-3 is simply inserted inside outer container 5, with no connection between containers 4 and 5. Accordingly, container 4 of packet 1 in FIGS. 4-7 swings in and out of container 5 about hinge 18, whereas container 4 of packet 1 in FIG. 1-3 slides in and out of container 5 a straight movement.

Packet 1 of cigarettes in FIGS. 1-7 comprises a rectangular coupon 19 in the form of a single or fan-folded sheet printed with advertising or pictures. Coupon 19 is located between inner container 4 and outer container 5, or rather, between a major lateral wall 8 of inner container 4 and a major lateral wall 14 of outer container 5, and is held on (i.e. made integral with) inner container 4 by a retaining tab 11a integral with inner container 4. More specifically, coupon 19 is inserted under retaining tab 11a, which holds it pressed against corresponding major lateral wall 8 of inner container 4 by elastic deformation.

When inner container 4 is in the closed position (FIGS. 1, 4, 6), coupon 19 rests on major lateral wall 8 of inner container 4 and, together with inner container 4, is inserted completely, and so concealed, inside outer container 5 (provided, of course, coupon 19 is at least slightly narrower than inner container 4, as shown in the drawings). When inner container 4 slides (translates or rotates) with respect to outer container 5 from the closed position (FIGS. 1, 4, 6) to the open position (FIGS. 2, 5, 7), coupon 19 is held integral with inner container 4 by retaining tab 11a, and so slides out of outer container 5 together with inner container 4. When inner container 4 is in the open position, coupon 19 is therefore also partly expelled from outer container 5, and may be withdrawn easily by the user from retaining tab 11a. The user, however, need not necessarily remove coupon 19 when inner container 4 is in the open position, in that, if inner container 4 is pushed back into the closed position, coupon 19 remains integral with inner container 4, and is inserted completely inside outer container 5 together with inner container 4.

It is important to note that coupon 19 in no way impairs performance of retaining tab 11a as a limit stop to prevent detachment of inner container 4 from outer container 5 by engaging corresponding retaining tab 17. On the contrary, by pushing retaining tab 11a outwards, coupon 19 actually promotes engagement of retaining tab 17 by retaining tab 11a.

In a different embodiment not shown, packet 1 of cigarettes comprises two coupons 19 located between inner container 4 and outer container 5, on opposite sides of inner container 4, and held contacting inner container 4 by retaining tabs 11a and 11b. This provides for a perfectly symmetrical packet 1 of cigarettes, which may contain two similar or different coupons 19.

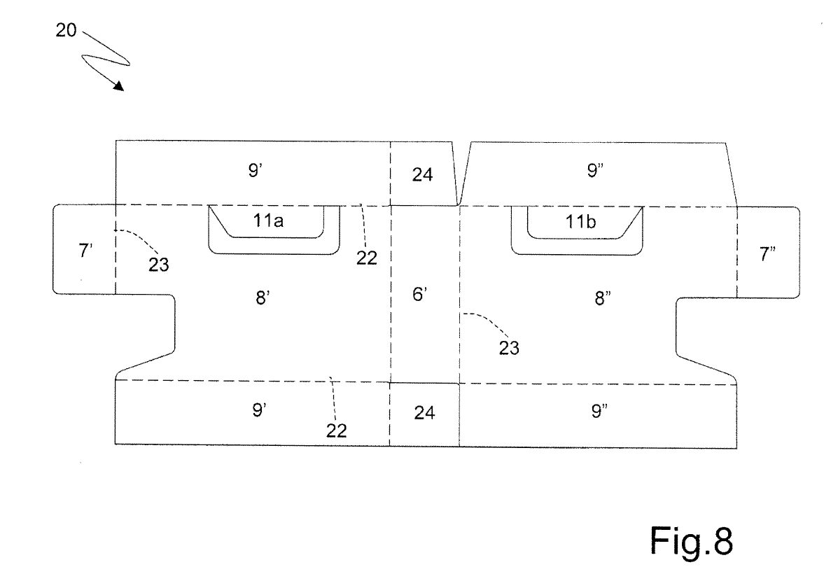

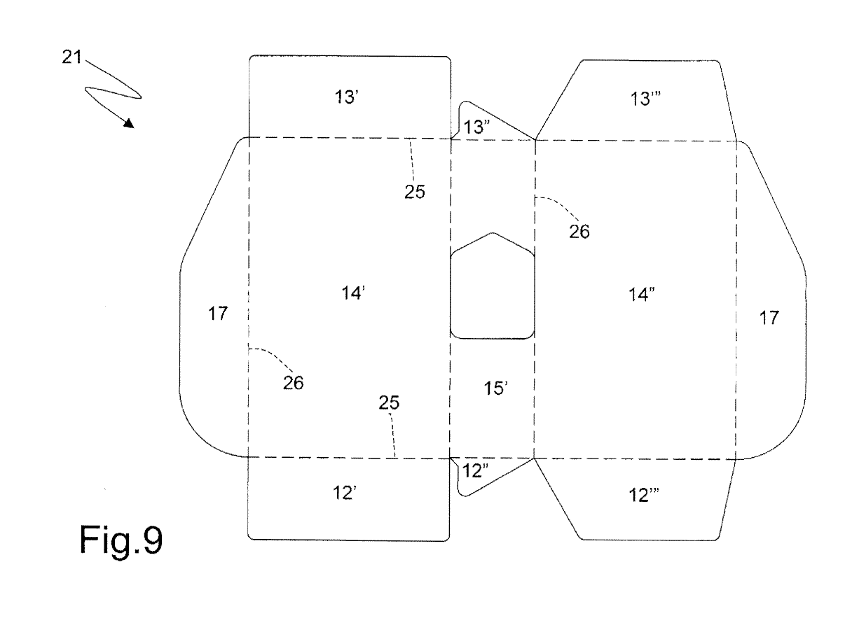

Containers 4 and 5 of packet 1 of cigarettes in FIGS. 1-3 are formed from respective known blanks 20 and 21 as shown in FIGS. 8 and 9 respectively. Each of blanks 20, 21 comprises, among other things, a number of panels, which are indicated, where possible, using the same reference numbers, with superscripts, as for the corresponding walls of respective container 4, 5.

With reference to FIG. 8, blank 20 has two longitudinal fold lines 22, and a number of transverse fold lines 23 defining, between longitudinal fold lines 22, a panel 7′ forming part of top wall 7; a panel 8′ forming one major lateral wall 8; a panel 6′ forming bottom wall 6; a panel 8″ forming the other major lateral wall 8; and a panel 7″ forming the rest of top wall 7.

Panel 8′ has two lateral wings 9′, which form respective inner portions of minor lateral walls 9, are located on opposite sides of panel 8′, and are separated from panel 8′ by longitudinal fold lines 22. Panel 8″ has two lateral wings 9″, which form respective outer portions of minor lateral walls 9, are located on opposite sides of panel 8″, and are separated from panel 8″ by longitudinal fold lines 22. Lateral wings 9″ of panel 8″ each have a tab 24 separated from lateral wing 9″ by a transverse fold line 23; and an opening defining a respective retaining tab 11 is formed in each panel 8′, 8″.

With reference to FIG. 9, blank 21 has two transverse fold lines 25, and a number of longitudinal fold lines 26 defining, between transverse fold lines 25, a panel 14′ forming a major lateral wall 14; a panel 15′ forming minor lateral wall 15; and a panel 14″ forming the other major lateral wall 14. Each panel 14′, 14″ has a retaining tab 17 located on the opposite side to panel 15′ and separated from respective panel 14′, 14″ by a longitudinal fold line 26.

Panel 14′ has two rectangular end wings 12′, 13′, which are located at opposite ends of panel 14′, are separated from panel 14′ by transverse fold line 25, and form respective outer portions of walls 12 and 13. Panel 15′ has two end wings 12″, 13″, which are located at opposite ends of panel 15′, are separated from panel 15′ by transverse fold line 25, are triangular in shape with a rounded outer apex, and form respective inner portions of walls 12 and 13. Panel 14″ has two trapezoidal end wings 12′″, 13′″, which are located at opposite ends of panel 14″, are separated from panel 14″ by transverse fold line 25, and form respective inner portions of walls 12 and 13. End wings 12″ and 12′″, and end wings 13″ and 13′″ are shaped so as not to overlap when folded onto end wings 12′ and 13′ to form walls 12 and 13 of outer container 5.

Containers 4 and 5 of packet 1 of cigarettes in FIGS. 4-7 are formed from respective known blanks almost identical to blanks 20 and 21 shown in FIGS. 8 and 9 and used to form containers 4 and 5 of packet 1 of cigarettes in FIGS. 1-3.

Attachment of coupon 19 to packet 1 of cigarettes is extremely straightforward and inexpensive.

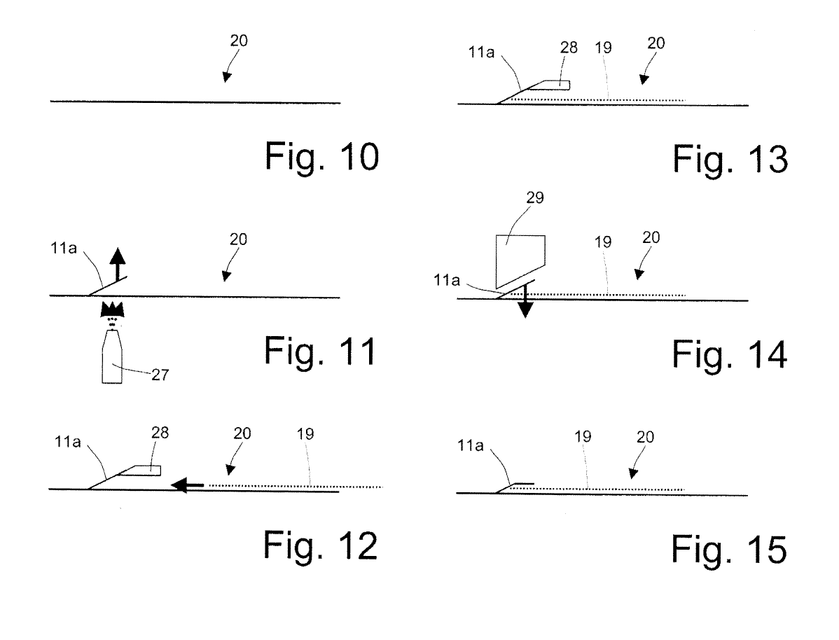

One way of attaching coupon 19 to packet 1 of cigarettes is shown in FIGS. 10-15, and comprises attaching coupon 19 to blank 20 of inner container 4 before folding blank 20. More specifically, starting with blank 20 spread out flat (FIG. 10), a folding device 27 folds retaining tab 11a about the corresponding longitudinal fold line 22 to lift retaining tab 11a (FIG. 11) off blank 20, or rather off panel 8′ of blank 20 forming a major lateral wall 8, so that retaining tab 11a is tilted at a given angle (e.g. at least 30°)to blank 20. Folding device 27 may, for example, comprise a blower, which directs a compressed-air jet onto retaining tab 11a (as shown in FIG. 11), or a finger which moves perpendicularly to blank 20 to push up retaining tab 11a. Once retaining tab 11a is lifted off blank 20, coupon 19 is inserted beneath retaining tab 11a and on top of panel 8′ forming a major lateral wall 8 (FIGS. 12 and 13). To hold retaining tab 11a up off panel 8′ of blank 20, i.e. to prevent retaining tab 11a from springing back into a position coplanar with panel 8′ of blank 20 when inserting coupon 19, a preferred embodiment comprises a support 28, which holds retaining tab 11a up and is located a given distance from blank 20 to permit insertion of coupon 19. Finally, a further folding device 29 folds retaining tab 11a down (i.e. towards blank 20 and about corresponding longitudinal fold line 22) back into a position substantially coplanar with panel 8′ (FIGS. 14 and 15). Due to coupon 19 inserted underneath it, retaining tab 11a obviously remains slightly raised with respect to panel 8′.

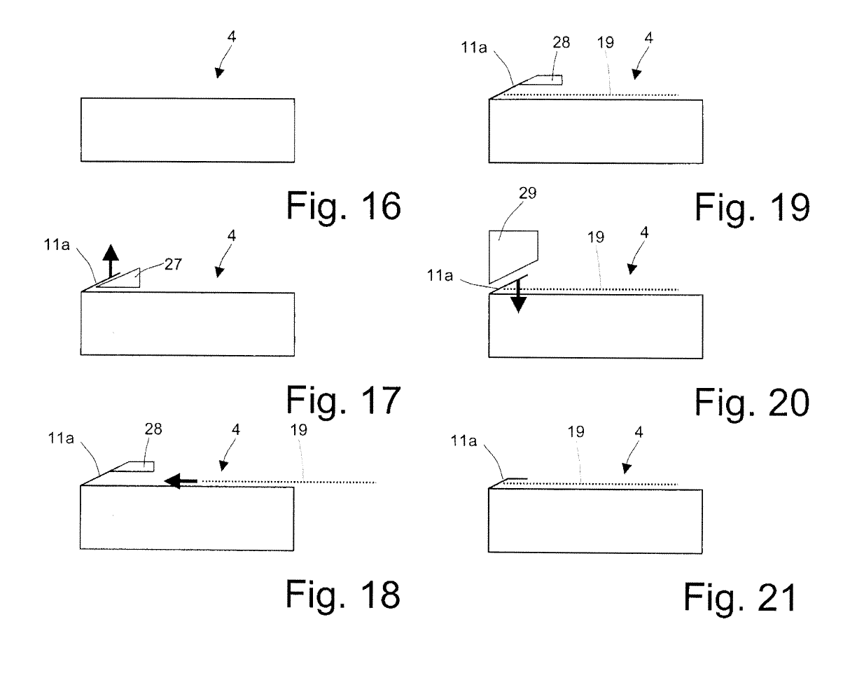

Another way of attaching coupon 19 to packet 1 of cigarettes is shown in FIGS. 16-21, and comprises attaching coupon 19 to inner container 4 (i.e. after blank 20 is at least partly folded about wrapped group 2) as opposed to the flat blank 20 before it is folded about wrapped group 2. In other words, as shown in FIGS. 16-21, coupon 19 is inserted beneath retaining tab 11a after blank 20 is either partly folded to form inner container 4, or is completely folded and inner container 4 is completed. The only difference between the FIG. 10-15 and the FIG. 16-21 procedures is in the design of folding device 27 for lifting retaining tab 11a off panel 8′ of blank 20 (i.e. off major lateral wall 8 of inner container 4). As shown in FIG. 17, because inner container 4 prevents retaining tab 11a from being raised from underneath, folding device 27 must comprise a wedge which eases beneath retaining tab 11a (the wedge is typically fixed and defines a folding screw, and inner container 4 is moved gradually with respect to the wedge).

It is important to note that, in the example shown in the drawings, support 28 is separate from and independent of folding device 27. In an alternative embodiment, support 28 may form part of folding device 27. Moreover, once coupon 19 is inserted beneath retaining tab 11a, retaining tab 11a may spring back on its own into a position substantially coplanar with panel 8′, so that folding device 29 may not be needed.

It is important to note that, once coupon 19 is inserted beneath retaining tab 11a, the elastic pressure exerted by retaining tab 11a on coupon 19 keeps coupon 19 in the correct position for follow-up processing (folding blank 20 about wrapped group 2 to form inner container 4 and/or folding blank 20 about inner container 4 to form outer container 5) with no need for any other external stabilizing means.

Packet 1 of cigarettes described has numerous advantages.

Firstly, in packet 1 of cigarettes described, coupon 19 is concealed when the packet is closed; is easy to remove when the packet is unsealed; need not necessarily be removed when the packet is unsealed, and may be left in its original position until the user decides to look at it; and, if removed, may be replaced in its original position, thus providing the user with a convenient, safe place in which to keep it.

Secondly, attachment of coupon 19 to packet 1 of cigarettes described is extremely straightforward, and the elastic pressure exerted on coupon 19 by retaining tab 11a keeps coupon 19 in the correct position, with no need for any other external stabilizing means.

Thirdly, in packet 1 of cigarettes described, coupon 19 may be almost the same size as major lateral walls 8 of inner container 4.

Finally, in packet 1 of cigarettes described, coupon 19 is strictly separate from wrapped group 2, thus preventing any alteration in the aroma of the tobacco by the colouring agents in the printing on coupon 19.

Given its numerous advantages, the design of packet 1 of cigarettes as described above also applies to the manufacture of a carton of cigarettes, which is substantially the same as packet 1, the only difference being that it contains a group of packets of cigarettes, as opposed to a group of cigarettes.

1) A slide-open package of tobacco articles, comprising:
a parallelepiped-shaped inner container (4) housing a group (2) of tobacco articles and having two opposite, parallel major lateral walls (8);
a parallelepiped-shaped outer container (5) having two opposite, parallel major lateral walls (14) and housing the inner container (4) to allow the inner container (4) to slide between a closed position, in which the inner container (4) is inserted inside the outer container (5), and an open position, in which the inner container (4) is at least partly withdrawn from the outer container (5); and
at least one coupon (19);
the package being characterized in that the coupon (19) is located between a first major lateral wall (8) of the inner container (4) and a first major lateral wall (14) of the outer container (5).

2) A package as claimed in claim 1, wherein the coupon (19) is integral with the first major lateral wall (8) of the inner container (4), so as to move together with the inner container (4) between the closed position and the open position.

3) A package as claimed in claim 2, wherein:
each of the major lateral walls (8) of the inner container (4) has an inner retaining tab (11) projecting outwards of the inner container (4);
each of the major lateral walls (14) of the outer container (5) has an outer retaining tab (17) projecting inwards of the outer container (5) from the major lateral wall (14), and which, as the inner container (4) is withdrawn, engages a corresponding inner retaining tab (1) of the inner container (4), to limit outward travel of the inner container (4) and prevent the inner container (4) from being withdrawn completely from the outer container (5); and
the coupon (19) is inserted under a first inner retaining tab (11a).

4) A package as claimed in claim 3, wherein the first inner retaining tab (11a) holds the coupon (19) pressed against the first major lateral wall (8) of the inner container (4) by elastic deformation.

5) A package as claimed in claim 3, wherein:
each inner retaining tab (11) projects outwards of the inner container (4) from an edge between a major lateral wall (8) and a minor lateral wall (9b) of the inner container (4); and
each outer retaining tab (17) is connected to the edge of a major lateral wall (14) of the outer container (5).

6) A package as claimed in claim 1, and comprising two coupons (19) located between the inner container (4) and the outer container (5), on opposite sides of the inner container (4).

7) A method of producing a slide-open package of tobacco articles comprising:
a parallelepiped-shaped inner container (4) housing a group (2) of tobacco articles and having two opposite, parallel major lateral walls (8);
a parallelepiped-shaped outer container (5) having two opposite, parallel major lateral walls (14) and housing the inner container (4) to allow the inner container (4) to slide between a closed position, in which the inner container (4) is inserted inside the outer container (5), and an open position, in which the inner container (4) is at least partly withdrawn from the outer container (5); and
at least one coupon (19);
the method being characterized by comprising the step of locating the coupon (19) between a major lateral wall (8) of the inner container (4) and a major lateral wall (14) of the outer container (5).

8) A method as claimed in claim 7, and comprising the further steps of making the coupon (19) integral with the major lateral wall (8) of the inner container (4), on as to move together with the inner container (4) between the closed position and the open position.

9) A method as claimed in claim 8, and comprising the further steps of:
raising a first retaining tab (11a) of the inner container (4) with respect to a panel (8′) forming the major lateral wall (8) of the inner container (4);
inserting the coupon (19) under the first retaining tab (11a) and onto the panel (8′) forming the major lateral wall (8) of the inner container (4); and
lowering the first retaining tab (11a), so the first retaining tab (11a) is substantially coplanar with the panel (8′), and the coupon (19) is inserted under the first retaining tab (11a).

10) A method as claimed in claim 9, and comprising the further step of keeping the first retaining tab (11a) raised with respect to the panel (8′) forming the major lateral wall (8), as the coupon (19) is inserted under the first retaining tab (11a) and onto the panel (8′).

11) A method as claimed in claim 9, wherein:
the inner container (4) is formed by folding a blank (20) comprising the panel (8′) forming the major lateral wall (8); and
the coupon (19) is inserted under the first retaining tab (11a) when the blank (20) is still flat, and before starting to fold the blank to form the inner container (4).

12) A method as claimed in claim 9, wherein:
the inner container (4) is formed by folding a blank (20) comprising the panel (8′) forming the major lateral wall (8); and
the coupon (19) is inserted under the first retaining tab (11a) after the blank (20) has been at least partly folded to form the inner container (4).

13) A method as claimed in claim 9, wherein:
the inner container (4) is formed by folding a blank (20) comprising the panel (8′) forming the major lateral wall (8); and
the coupon (19) is inserted under the first retaining tab (11a) after the blank (20) has been folded completely to form the inner container (4), and the inner container (4) is therefore completed.
